(19) United States
(12) Patent Application Publication
(10) Pub. No.: US 2003/0009457 A1
(43) Pub. Date: Jan. 9, 2003

(54) Image interception method

(76) Inventor: William Lu, Taipei (TW)

Correspondence Address: BIRCH STEWART KOLASCH & BIRCH, PO BOX 747, FALLS CHURCH, VA, 22040-0747, US

(21) Appl. No.: 10/066,689

(22) Filed: Feb. 6, 2002

(30) Foreign Application Priority Data
Jun. 22, 2001 (TW) 90115240

(51) Int. Cl. G06F 7/00

(52) U.S. Cl. 707/6

(57) ABSTRACT

An image interception method. First, a document having at least one image is provided, and the image in the document is obtained and recognized. Finally, the image is intercepted if the image is recognized as an objectionable image, and the image is displayed if the image is not recognized as an objectionable image.

### BACKGROUND OF THE INVENTION

1. Field of the Invention

The present invention relates to an image interception method, and particularly to an image interception method that recognizes the images attached to a document and/or linked to within the document, intercepting the images according to the recognition results.

2. Description of the Related Art

With the vigorous development of the Internet, web sites are established rapidly and a variety of content is thus available. However, there is no effective mechanism to classify these web sites or the contents, for preventing children or students from avoid browsing web sites with unacceptable material.

Conventional methods of intercepting unacceptable material, record the IP addresses of the unacceptable material or the links to the unacceptable material to achieve the interception.

FIG. 1 shows a flow chart illustrating the operation of a conventional method of intercepting unacceptable material. First, an address table is provided in the system (step S11). The address table records IP addresses of the unacceptable material in advance. Then, a target address is compared with the IP addresses recorded in the address table before the browser displays the web site or web page indicated by the target address (step S12).

The web site is intercepted if the target address matches one IP address in the address table (step S13), that is, the web site is not downloaded. The web site is downloaded and shown in the browser if the target address does not match any IP address in the address table (step S14).

However, the conventional method is not always effective, since the IP addresses of the unacceptable material or the links thereto can be changed frequently. In order to achieve better results, the address table must be updated regularly. Additionally, there is no automatic mechanism to search for IP address of unacceptable material and update the address table. As a result, the conventional method has limited effectiveness in intercepting unacceptable material.

### SUMMARY OF THE INVENTION

It is therefore an object of the present invention to provide an image interception method that recognizes the images attached to a document and/or linked to within the document, in order to intercept target images according to the recognition results.

To achieve the above object, the present invention provides an image interception method. First, a document having at least one image attached and/or at least one link to an image is provided. Then, the image in the document is obtained and recognized. Finally, the image is intercepted if the image is recognized as an objectionable image, and the image is displayed if the image is not recognized as an objectionable image.

According to the embodiment, the document may be a webpage, email message, a document generated within an office productivity application, and/or PDF document. Further, the image is obtained by reading the image attached to the document directly , and/or reading through a link contained in the document. Furthermore, the image is recognized by a recognition module, and the recognition module can be set for sensitivity, so as to achieve a desired level of selectivity.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flow chart illustrating the operation of a conventional method of intercepting unacceptable material;

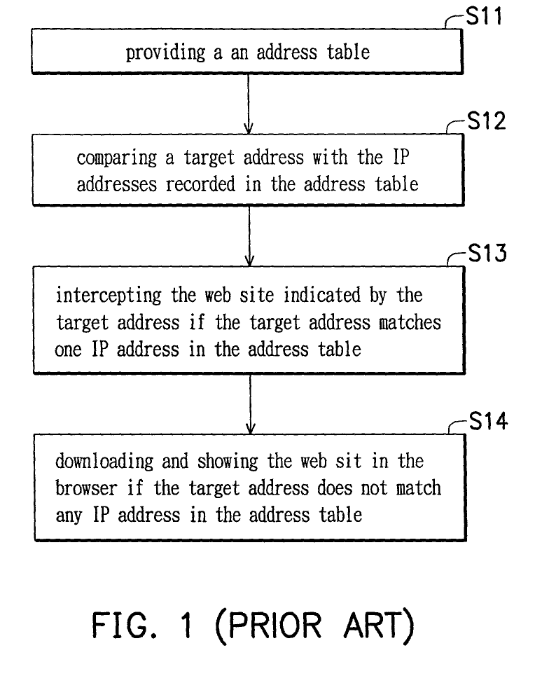

FIG. 2 is a flow chart illustrating the operation of an image interception method according to the embodiment of the present invention.

### DETAILED DESCRIPTION OF THE PREFERRED EMBODIMENT

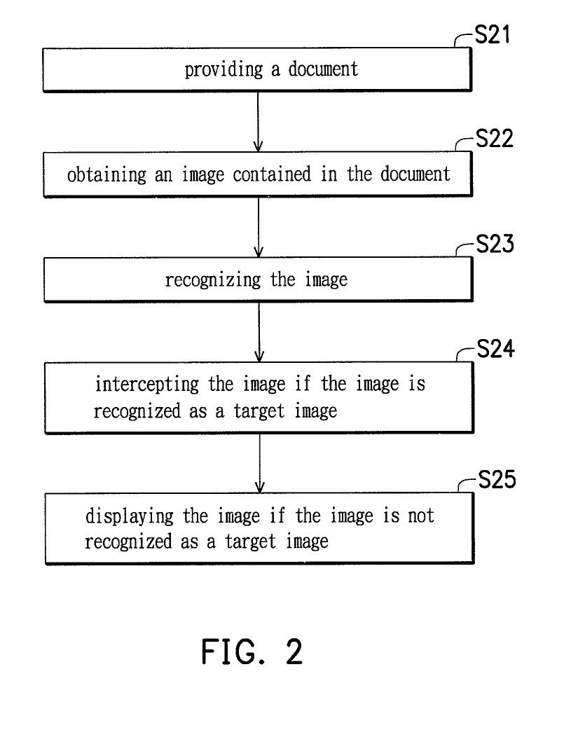

FIG. 2 shows a flow chart illustrating the operation of an image interception method according to the embodiment of the present invention. Referring to FIG. 2, the embodiment of the present invention is described as follows.

First, in steps S21, a document to be browsed is provided, with at least one image attached and/or at least one link to an image. The document may be a webpage, email message, a document generated within an office productivity application, PDF document, and/or any type of document containing images or links to images.

Then, the document is opened, and in step S22, the image contained in the document is obtained. It should be noted that attached images can be obtained by reading the image directly or through any links contained in the document.

Thereafter, in step S23, the image is scrutinized (recognized) by a recognition module, to determine whether the image is an objectionable image. The recognition module can be set for sensitivity, so as to enable classification or parent control.

Finally, in step S24, the image is intercepted (not displayed) if the image is recognized as an objectionable image (target image), and in step S25, the image is displayed if the image is not recognized as an objectionable image (target image).

In the above descriptions, the document may contain several images and/or several links to images. If the document contains several images, each of the images has to be recognized individually, and steps S24 and S25 are repeated for each of the images.

In addition, the present invention can be applied to browsers or email reading modules. For example, the image interception method of the present invention can be employed within the browsers provided for children or students. By way of setting the sensitivity of the recognition module, the possibility of browsing unacceptable material can be avoided.

As a result the image interception method according to the present invention can recognize the images attached to a document and/or linked to within the document, so as to determine whether the images are objectionable images, thus to intercept the images according to the recognition results.

Examples of objectionable content may include but are not limited to, images containing sexual or adult-oriented themes.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An image interception method, comprising the steps of:
providing a document;
obtaining an image contained in the document;
recognizing the image; and
intercepting the image if the image is recognized as an objectionable image .

2. The method as claimed in claim 1 further opening the document.

3. The method as claimed in claim 1 further showing the image if the image is not recognized as an objectionable image.

4. The method as claimed in claim 1 wherein the image can be obtained by reading the image directly if the image is attached to the document.

5. The method as claimed in claim 1 wherein the image can be obtained by reading the image through a link if the image is linked to within the document.

6. The method as claimed in claim 1 wherein the image is recognized by a recognition module.

7. The method as claimed in claim 6 further setting the sensitivity of the recognition module.

8. The method as claimed in claim 1 wherein the document is a webpage.

9. The method as claimed in claim 1 wherein the document is an email message.

10. The method as claimed in claim 1 wherein the document is a document generated within an office productivity application.

11. The method as claimed in claim 1 wherein the document is a PDF document.

12. The method as claimed in claim 1 wherein the objectionable image contains sexual themes.
